(19) United States
(12) Patent Application Publication
(10) Pub. No.: US 2023/0411731 A1
(43) Pub. Date: Dec. 21, 2023

(54) IMMERSION COOLING SYSTEM AND MANUFACTURING METHOD OF IMMERSION COOLING SYSTEM

(71) Applicant: HYUNDAI MOBIS CO., LTD., Seoul (KR)

(72) Inventors: Young Chan YOON, Anyang-si (KR); Hae Jin OH, Seongnam-si (KR)

(73) Assignee: HYUNDAI MOBIS CO., LTD., Seoul (KR)

(21) Appl. No.: 18/087,961

(22) Filed: Dec. 23, 2022

(30) Foreign Application Priority Data
Jun. 16, 2022 (KR) 10-2022-0073485

(51) Int. Cl. H01M 10/6557; H01M 10/651; H01M 10/6567

(52) U.S. Cl. CPC H01M 10/6557; H01M 10/651; H01M 10/6567; H01M 10/613

(57) ABSTRACT

Provided is an immersion cooling system, and more particularly, an immersion cooling system which may more efficiently manage a temperature of a battery. The immersion cooling system may increase a heat exchange area and solve a problem of a high temperature of a cell core by positioning a plurality of cooling paths through each of which a cooling fluid flows in surface pressure pads stacked on each other between battery cells.

### CROSS-REFERENCE TO RELATED APPLICATIONS

This application claims priority under 35 U.S.C. § 119 to Korean Patent Application No. 10-2022-0073485, filed on Jun. 16, 2022, in the Korean Intellectual Property Office, the disclosure of which is incorporated herein by reference in its entirety.

### TECHNICAL FIELD

The following disclosure relates to an immersion cooling system, and more particularly, to an immersion cooling system which may more efficiently manage a temperature of a battery.

### BACKGROUND

Mileage may be one of the most important factors that a consumer considers when choosing an electric vehicle. In response to this need, a capacity of a battery cell installed in the electric vehicle has been increasing, which may require more current. In addition, the increased capacity and high output condition of the battery cell may be inevitable in a current vehicle market in a trend for developing a high-power electric vehicle that surpasses a high-performance internal combustion engine vehicle, which may cause an increased amount of heat occurring in a battery. However, an indirect cooling method used in the prior art may have a limitation in managing a temperature of such a high-performance battery.

An indirect water cooling method may be a common conventional indirect cooling technology used for cooling the battery. In the indirect water cooling method, a bottom surface of the battery cell may mainly be in contact with a cooling block together with a heat transfer interface material, and have a heat transfer path such as a coolant—the cooling block—the heat transfer material—the battery cell. Here, contact heat resistance may occur in a contact portion of each component, and in particular, the heat transfer material having electrical insulation may have very low cooling efficiency due to its low thermal conductivity. In addition, the cooling block may be in contact with only the bottom surface of the battery, and accordingly, the top of the battery, which is the farthest away from the cooling block, may not be cooled.

An immersion cooling method has been proposed to solve this problem. The immersion cooling method may perform cooling by an insulating fluid which is in direct contact with the battery cell while being moved to the upper/lower part of the battery, and have good cooling efficiency by including a simple heat transfer path compared to the indirect water cooling method described above. Still, a battery core may not be cooled by this method.

### SUMMARY

Embodiments of the present disclosure are directed to providing an immersion cooling system which may increase a heat exchange area and solve a problem of a high temperature of a cell core by positioning a plurality of cooling paths through each of which a cooling fluid flows in surface pressure pads stacked on each other between battery cells, and a manufacturing method of an immersion cooling system.

Embodiments of the present disclosure are directed to providing an immersion cooling system which may increase stability of a battery by not only distributing heat of a battery cell by further including a distribution plate between a surface pressure pad and the battery cell, but also preventing a pressure from being concentrated on a specific portion thereof as a cooling path is positioned on a surface pressure pad, and a manufacturing method of an immersion cooling system.

In one general aspect, an immersion cooling system applied to a battery module including a plurality of battery cells includes: a surface pressure pad interposed between the plurality of the battery cells and including a cooling path; and a cooling fluid to flow through the cooling path, wherein the cooling path passes through one end and the other end of the surface pressure pad.

The cooling path may pass through one end and the other end of the surface pressure pad in a straight line.

The cooling path may have a curved shape to include at least one curve of the surface pressure pad.

The cooling path may include two or more cooling paths, the cooling paths may be stacked above each other at a predetermined interval in a width direction of the surface pressure pad, and a sum of inner diameters of the cooling paths may be 1% or more and less than 10% of a total width of the surface pressure pad.

The surface pressure pad may include a core region in contact with a core of the battery cell and two outer regions respectively in contact with upper and lower portions of the battery cell, the core region may not include the cooling path, and each of the two outer regions may include at least one cooling path.

At least one of the two outer regions may include two or more cooling paths, and the closer to the top or bottom of the battery cell, the shorter a separation distance between the cooling paths.

The cooling path may include a first cooling path and a second cooling path, inlets from which the cooling fluidflows into the first cooling path and the second cooling path may respectively disposed at one end and the other end of the surface pressure pad in a length direction of the surface pressure pad for the cooling fluid to flow in a predetermined first direction in the first cooling pathand for the cooling fluid to flow in a second direction opposite to the first direction in the second cooling path.

At least a portion of the cooling path may include a pipe covering therein for the cooling fluid to be separated from the surface pressure pad and the battery cell without being in contact therewith.

The system may further include a distribution plate stacked between the surface pressure pad and the battery cell.

The cooling path may include two or more cooling paths, the cooling paths may be stacked above each other at a predetermined interval in a width direction of the surface pressure pad, and a sum of inner diameters of the cooling paths may be 10% or more and less than 30% of a total width of the surface pressure pad.

In another general aspect, a method of manufacturing an immersion cooling system includes: operation (a) including optimizing a numerical value related to a shape or inner diameter of a cooling path based on at least one of physical properties of a surface pressure pad and a cooling fluid, and an expected heat occurrence and size of a battery cell; operation (b) including forming the cooling path passing through the surface pressure pad based on the numerical value specified in the operation (a); and operation (c) including stacking the battery cell and the surface pressure pad processed in the operation (b).

The method may further include operation (d), performed prior to the operation (C), including stacking a plurality of the battery cells by coupling a dispersion plate and the surface pressure pad with each other. Other features and aspects will be apparent from the following detailed description, the drawings, and the claims.

### BRIEF DESCRIPTION OF THE DRAWINGS

FIG. 1 is a perspective view of a battery module to which an immersion cooling system of the present disclosure is applied.

FIG. 2 is a cross-sectional view of the battery module to which the immersion cooling system of the present disclosure is applied.

FIG. 3 is a cross-sectional view of a battery module to which an example of the immersion cooling system of the present disclosure is applied.

FIG. 4 is a plan view showing a first example of a cooling path of the present disclosure.

FIG. 5 is a graph showing heat distribution of a battery cell when the first example of the cooling path of the present disclosure is not applied.

FIG. 6 is a graph showing heat distribution of the battery cell when the first example of the cooling path of the present disclosure is applied.

FIG. 7 is a plan view showing a second example of the cooling path of the present disclosure.

FIG. 8 is a plan view showing a third example of the cooling path of the present disclosure.

FIG. 9 is a plan view showing a fourth example of the cooling path of the present disclosure.

FIG. 10 is a flowchart showing a manufacturing method of an immersion cooling system of the present disclosure.

### DETAILED DESCRIPTION OF EMBODIMENTS

Hereinafter, the technical spirit of the present disclosure will be described in more detail with reference to the accompanying drawings. Terms and words used in this specification and claims are not to be construed as a general or dictionary meaning, but are to be construed as meanings and concepts meeting the technical ideas of the present disclosure based on a principle that the inventors may appropriately define the concepts of terms in order to describe their inventions in best mode.

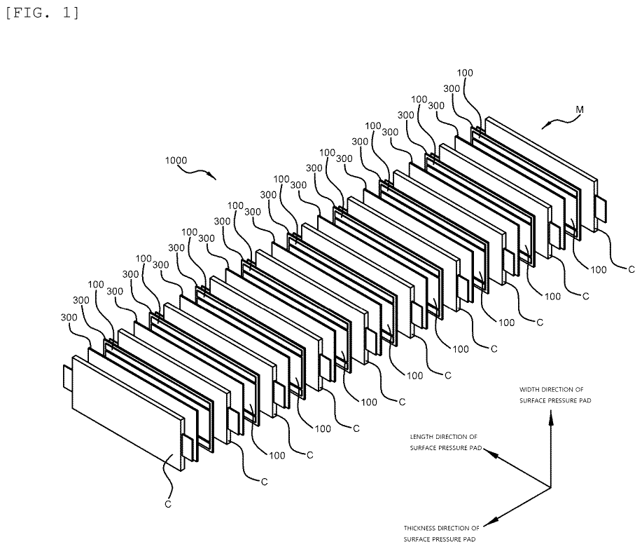

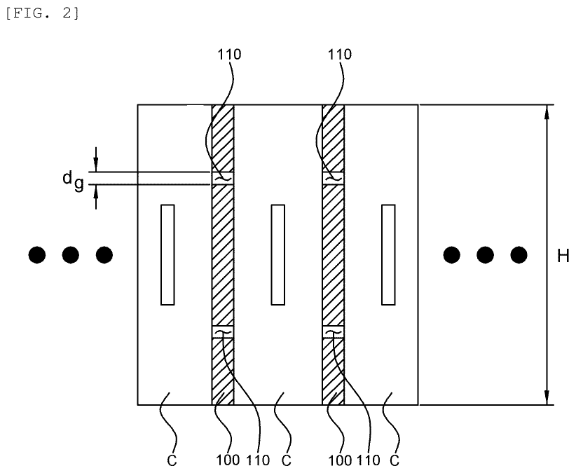

Hereinafter, a basic configuration of an immersion cooling system 1000 of the present disclosure is described with reference to FIGS. 1 and 2.

In the present disclosure, the immersion cooling system 1000 may be applied to a battery module M including a plurality of battery cells C, and include a surface pressure pad 100 interposed between the battery cells C as shown in FIG. 2. The surface pressure pad 100 and the battery cell C may be stacked on each other in a thickness direction of the surface pressure pad 100 of FIG. 1. In addition, the surface pressure pad 100 may include a cooling path 110, and in this case, the cooling path 110 may pass through one end and the other end of the surface pressure pad 100. In more detail, the cooling path 110 may pass through the surface pressure pad 100 in a length direction of the surface pressure pad 100 of FIG. 2. In addition, the immersion cooling system 1000 of the present disclosure may include a cooling fluid 200 flowing through the cooling path 110. Accordingly, the cooling fluid 200 may flow and contact both sides of the battery cell C, and a heat path may be formed. Accordingly, the entire battery cell C may be easily cooled.

In addition, two or more cooling paths 110 may be formed in a width direction of the surface pressure pad 100 of FIG. 1. For example, each cooling path 110 may be formed while completely dividing the surface pressure pad 100. That is, the cooling path 110 may be in direct contact with the battery cell C in the thickness direction of the surface pressure pad 100, and may be in contact with the surface pressure pad 100 in the width direction of the surface pressure pad 100. Accordingly, the battery cell C and the cooling fluid 200 of the cooling path 110 may be in direct contact with each other, thereby minimizing contact heat resistance. In general, the surface pressure pad 100 may be made of a material having electrical insulation, and have large heat resistance, and thus maximizing cooling efficiency by having this shape.

In addition, as shown in FIG. 2, the cooling paths 110 may be stacked above each other at a predetermined interval in the width direction of the surface pressure pad 100, and a sum of thicknesses d g of the surface pressure pad 100 of the cooling path 110 in the width direction may be 1% or more and less than 10% of a total width of the surface pressure pad 100.

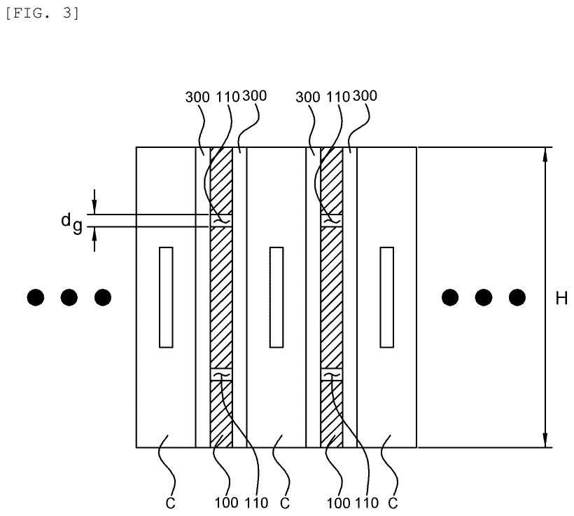

Hereinafter, an example of the immersion cooling system 1000 of the present disclosure is described with reference to FIG. 3.

As shown in FIG. 3, the immersion cooling system 1000 of the present disclosure may further include a distribution plate 300 stacked between the surface pressure pad 100 and the battery cell C. The distribution plate 300 may use a material having rigidity and thermal conductivity, greater than or equal to a predetermined level, and its specific physical property may be easily changed based on physical properties of the surface pressure pad 100 and the cooling fluid 200. By including the distribution plate 300, the immersion cooling system may distribute a pressure applied to the surface pressure pad 100, maintain shapes of the battery cell C, the surface pressure pad 100 and the cooling path 110 when a swelling phenomenon of the battery cell C occurs, and increase stability of the entire battery module M. The distribution plate 300 may have high thermal conductivity to thus minimize the contact heat resistance even when interposed between the cooling fluid 200 and the battery cell C, thus maintaining the cooling efficiency.

The cooling paths 110 may be stacked above each other at a predetermined interval in the width direction of the surface pressure pad 100, and the sum of the thicknesses d g of the surface pressure pad 100 of the cooling path 110 in the width direction may be 10% or more and less than 30% of the total width of the surface pressure pad 100. That is, a share of the cooling path 110 may be increased compared to when the distribution plate 300 is not applied to the system. This configuration is to compensate for a slight increase in the contact heat resistance due to additional stacking of the distribution plate 300.

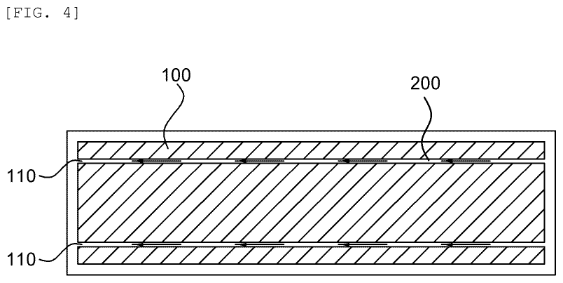

Hereinafter, the description describes examples of the cooling path 110 of the present disclosure with reference to FIGS. 4 to 9.

### First Example

As shown in FIG. 4, the cooling path 110 may pass through one end and the other end of the surface pressure pad 100 in a straight line. That is, the cooling path 110 may pass through the surface pressure pad 100 in the length direction. The cooling fluid 200 may flow and contact both the sides of the battery cell C, and the heat path may be formed. Accordingly, the entire battery cell C may be easily cooled, and the cooling path 110 may be formed in a straight line to thus simplify a process of forming the cooling path 110 in the surface pressure pad 100, thereby reducing a manufacturing cost.

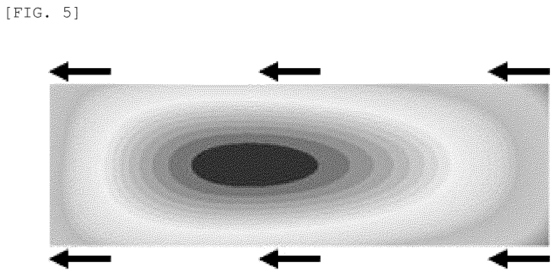

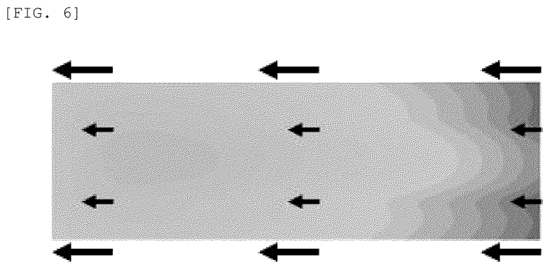

Hereinafter, the description demonstrates an effect of the immersion cooling system 1000 of the present disclosure in more detail based on contents described with reference to FIGS. 5 and 6. Each arrow shown in the drawings represents a flow direction of the cooling fluid 200. As shown in FIG. 5, in the prior art, a cooling plate or a cooling fluid 200 may be in contact only with the upper or lower portion of a battery cell C, and heat may thus be concentrated on a core of a battery. On the other hand, the immersion cooling system 1000 to which the first example of the cooling path 110 of the present disclosure is applied may be installed in the battery module M. In this case, as shown in FIG. 6, several cooling paths 110 may be arranged in the surface pressure pad 100 in the width direction to thus cool all the cores of the battery cells C, and the temperatures of all the battery cells C may thus be maintained low.

### Second Example

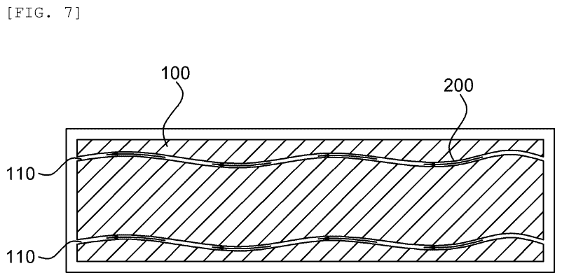

As shown in FIG. 7, the cooling path 110 may have a curved shape to include at least one curve of the surface pressure pad 100. The cooling path 110 may include the curve to thus increase a flow distance when the cooling fluid 200 flows in the surface pressure pad 100 in the length direction, and extend contact time between the cooling fluid 200 and the battery cell C. In addition, the cooling path 110 may include the curve to thus maximize an area of the battery cell C exchanging heat with the cooling fluid 200 compared to the cooling path 110 of Example 1 that is formed in the straight line.

In addition, all curve angles of the cooling path 110 in the second example may be less than 90 degrees. Accordingly, it is possible to minimize the stalling or stagnation of the cooling fluid 200 flowing in the cooling path 110.

### Third Example

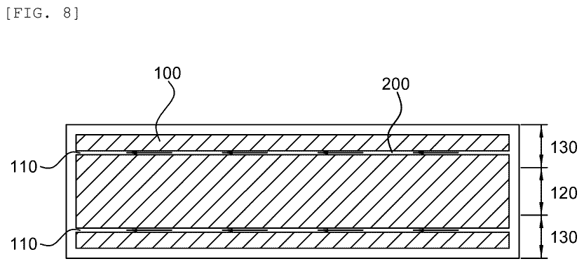

As shown in FIG. 8, the cooling path 110 may be disposed only in an outer region 130 of the battery cell C rather than a core region 120 thereof. More clearly, the surface pressure pad 100 may include the core region 120 in contact with the core of the battery cell C and two outer regions 130 respectively in contact with the upper and lower portions of the battery cell C. Here, the core region 120 may be a region where the swelling phenomenon of the battery cell C occurs most, and spaced apart from a plane passing through a width center of the surface pressure pad 100 by 10% to 30% of a total width length H. The outer region 130 may be a region that does not overlap the core region 120, and may be a region in contact with the upper or lower portion of the battery cell C (based on the width direction of the surface pressure pad 100). Accordingly, the swelling phenomenon of the battery cell C may be suppressed by maintaining a load between the surface pressure pad 100 and the battery cell C in the core region 120. The core region 120 may not include the cooling path 110, and each outer region 130 may include at least one cooling path 110.

Furthermore, the outer region 130 may include two or more cooling paths 110, and in this case, the closer to the top or bottom of the battery cell C, the shorter a separation distance between the cooling paths 110. The battery cell C has a large swelling phenomenon sequentially from the core, and the cooling paths 110 may thus be more densely arranged as being farther away from the core of the battery cell C, thereby not only having no effect on a role of the surface pressure pad 100 to prevent the swelling phenomenon, but also maintaining high cooling efficiency.

### Fourth Example

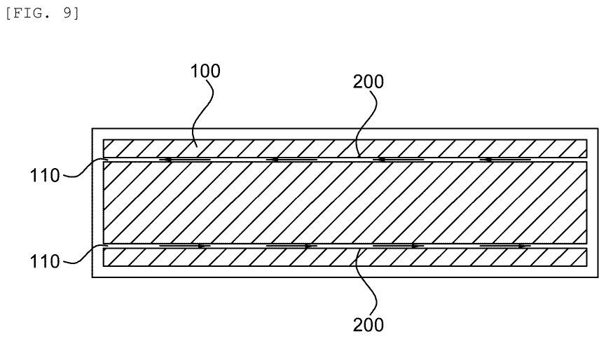

As shown in FIG. 9, the cooling fluids 200 may flow in different directions in the respective cooling paths 110. In more detail, the cooling fluid 200 flowing in a first cooling path 111, which is one of the cooling paths 110, may flow in a predetermined first direction, and the cooling fluid 200 flowing in a second cooling path 112, which is another one of the cooling paths 110, may flow in a second direction opposite to the first direction. To this end, inlets into which the cooling fluid 200 of the first cooling path 111 and that of the second cooling path 110 are fed may respectively be formed at one end and the other end of the surface pressure pad 100 in the length direction. Furthermore, the inlet of the first cooling path 111 and an outlet of the second cooling path 112 or an outlet of the first cooling path 111 and the inlet of the second cooling path 112 may be connected with each other, and the cooling fluid 200 may thus be circulated and absorb heat of the battery cell C.

As such, the cooling fluids 200 may flow in the different directions, and accordingly, heat may not be concentrated in one portion of the battery cell C and heat may thus be absorbed simultaneously in several directions. Accordingly, it is possible to increase the cooling time and efficiency. In addition, the inlet and outlet of the respective cooling paths 110 through which the fluids flow in the different directions may be connected with each other to thus circulate the cooling fluid 200, thereby reducing the cooling time and consumption of the cooling fluid 200.

### Fifth Example

Alternatively, at least a portion of the cooling path 110 may include a pipe-type covering (not shown) for the cooling fluid 200 to be separated from the surface pressure pad 100 and the battery cell C without being in contact therewith. Here, the pipe-type covering may use a material having low contact heat resistance. The pipe-type covering may be a rigid body having predetermined rigidity, or may be a polymeric composite material having thermal conductivity.

In this way, the cooling path 110 may further include the pipe-type covering therein to thus prevent the cooling fluid 200 from being in direct contact with the surface pressure pad 100 and the battery cell C, and significantly reduce a probability of a problem occurring due to leakage of the cooling fluid 200. In addition, the position and shape of the cooling path 110 may be fixed to thus smoothly perform the inflow and discharge of the cooling fluid 200 even when external pressure occurs inside and outside of the battery cell C due to a cause such as its swelling phenomenon.

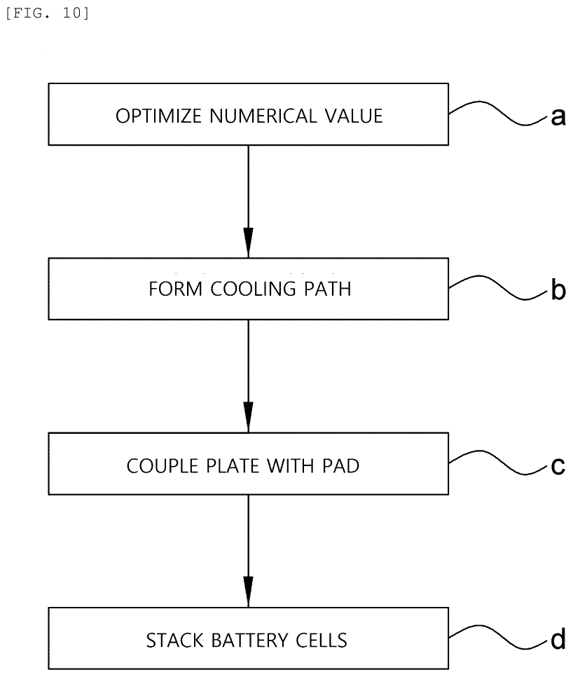

Hereinafter, the description describes a manufacturing method of an immersion cooling system 1000 of the present disclosure with reference to FIG. 10.

As shown in FIG. 10, the manufacturing method of an immersion cooling system 1000 according to the present disclosure for manufacturing the immersion cooling system 1000 includes: operation (a) of optimizing a numerical value related to the shape or inner diameter of a cooling path 110 based on at least one of physical properties of a surface pressure pad 100 and a cooling fluid 200, and the expected heat occurrence and size of a battery cell C. A sum of thicknesses dg of the surface pressure pad 100 of the cooling path 110 in a width direction may be 1% or more and less than 10% of a total width H of the surface pressure pad 100. However, a distribution plate 300 may be applied in an example of the present disclosure, and in this case, the sum of the thicknesses dg of the surface pressure pad 100 of the cooling path 110 in the width direction may be 1% or more and less than 10% of the total width H of the surface pressure pad 100.

In addition, the manufacturing method of an immersion cooling system 1000 of the present disclosure includes: operation (b) of forming the cooling path 110 passing through the surface pressure pad 100 based on the numerical value specified in operation (a); and operation (c) of stacking the battery cell C and the surface pressure pad 100 processed in operation (b). Here, in operation (b), two or more cooling path 110 may be formed in the surface pressure pad 100 in the width direction.

For example, each cooling path 110 may be formed while completely dividing the surface pressure pad 100. That is, the cooling path 110 may be in direct contact with the battery cell C in a thickness direction of the surface pressure pad 100, and may be in contact with the surface pressure pad 100 in the width direction of the surface pressure pad 100. Accordingly, the battery cell C and the cooling fluid 200 of the cooling path 110 may be in direct contact with each other, thereby minimizing contact heat resistance. In general, the surface pressure pad 100 may be made of a material having electrical insulation, have large heat resistance, and thus maximizing cooling efficiency by having this shape.

Here, in another embodiment of the present disclosure, the method may further include operation (d) performed prior to operation (C), and of stacking the battery cells C by coupling the dispersion plate 300 and the surface pressure pad 100 with each other. The distribution plate 300 may use a material having rigidity and thermal conductivity, greater than or equal to a predetermined level, and its specific physical property may be easily changed based on physical properties of the surface pressure pad 100 and the cooling fluid 200. By the immersion cooling system including the distribution plate 300, the method may distribute a pressure applied to the surface pressure pad 100, maintain shapes of the battery cell C, the surface pressure pad 100 and the cooling path 110 when a swelling phenomenon of the battery cell C occurs, and increase stability of the entire battery module M. The distribution plate 300 may have high thermal conductivity to thus minimize the contact heat resistance even when interposed between the cooling fluid 200 and the battery cell C, thus maintaining the cooling efficiency.

As set forth above, according to the immersion cooling system including the configuration as described above and the manufacturing method of an immersion cooling system of the present disclosure, it is possible to increase the heat exchange area and solve the problem of the high temperature of the cell core by positioning the plurality of cooling paths through each of which the cooling fluid flows in the surface pressure pads stacked on each other between the battery cells.

It is also possible to increase the stability of the battery by not only distributing the heat of the battery cell by further including the distribution plate between the surface pressure pad and the battery cell, but also preventing the pressure from being concentrated on a specific portion thereof as the cooling path is positioned on the surface pressure pad.

The spirit of the present disclosure should not be limited to the embodiments described above. The present disclosure may be applied to various fields and may be variously modified by those skilled in the art without departing from the scope of the present disclosure claimed in the claims. Therefore, it is obvious to those skilled in the art that these alterations and modifications fall within the scope of the present disclosure.

What is claimed is:

1. An immersion cooling system applied to a battery module including a plurality of battery cells, the system comprising:
a surface pressure pad interposed between the plurality of the battery cells and including a cooling path; and
a cooling fluid to flow through the cooling path,
wherein the cooling path passes through one end and the other end of the surface pressure pad.

2. The system of claim 1, wherein the cooling path passes through one end and the other end of the surface pressure pad in a straight line.

3. The system of claim 1, wherein the cooling path has a curved shape to include at least one curve of the surface pressure pad.

4. The system of claim 1, wherein the cooling path includes two or more cooling paths,
the cooling paths are stacked above each other at a predetermined interval in a width direction of the surface pressure pad, and
a sum of inner diameters of the cooling paths is 1% or more and less than 10% of a total width of the surface pressure pad.

5. The system of claim 1, wherein the surface pressure pad includes a core region in contact with a core of the battery cell and two outer regions respectively in contact with upper and lower portions of the battery cell,
the core region does not include the cooling path, and
each of the two outer regions includes at least one cooling path.

6. The system of claim 5, wherein at least one of the two outer regions includes two or more cooling paths, and
the closer to a top or bottom of the battery cell, the shorter a separation distance between the cooling paths.

7. The system of claim 5, wherein the cooling path includes a first cooling path and a second cooling path, and inlets from which the cooling fluid flows into the first cooling path and the second cooling path are respectively disposed at one end and the other end of the surface pressure pad in a length direction of the surface pressure pad for the cooling fluid to flow in a predetermined first direction in the first cooling path and for the cooling fluid to flow in a second direction opposite to the first direction in the second cooling path.

8. The system of claim 1, wherein at least a portion of the cooling path includes a pipe covering therein for the cooling fluid to be separated from the surface pressure pad and the battery cell without being in contact therewith.

9. The system of claim 1, further comprising a distribution plate stacked between the surface pressure pad and the battery cell.

10. The system of claim 9, wherein the cooling path includes two or more cooling paths,
the cooling paths are stacked above each other at a predetermined interval in a width direction of the surface pressure pad, and
a sum of inner diameters of the cooling paths is 10% or more and less than 30% of a total width of the surface pressure pad.

11. A method of manufacturing an immersion cooling system, the method comprising:
operation (a) including optimizing a numerical value related to a shape or inner diameter of a cooling path based on at least one of physical properties of a surface pressure pad and a cooling fluid, and an expected heat occurrence and size of a battery cell;
operation (b) including forming the cooling path passing through the surface pressure pad based on the numerical value specified in the operation (a); and
operation (c) including stacking the battery cell and the surface pressure pad processed in the operation (b).

12. The method of claim 11, further comprising operation (d), performed prior to the operation (c), including stacking a plurality of the battery cells by coupling a dispersion plate and the surface pressure pad with each other.
